(19) United States
(12) Patent Application Publication
(10) Pub. No.: US 2026/0246200 A1
(43) Pub. Date: Aug. 20, 2026

(54) COAXIAL CONNECTOR AND COAXIAL CONNECTOR CONNECTION STRUCTURE

(71) Applicants: AUTONETWORKS TECHNOLOGIES, LTD., Mie (JP); SUMITOMO WIRING SYSTEMS, LTD., Mie (JP); SUMITOMO ELECTRIC INDUSTRIES, LTD., Osaka (JP)

(72) Inventors: Yasunori ASANO, Mie (JP); Hiroyuki ISHIGURE, Mie (JP)

(21) Appl. No.: 19/489,586

(22) PCT Filed: May 28, 2024
(86) PCT No.: PCT/JP2024/019463

§ 371 Date: Dec. 3, 2025

(30) Foreign Application Priority Data
Jun. 7, 2023 (JP) 2023-093722

(51) Int. Cl. H01R 13/631; H01R 13/187; H01R 13/64; H01R 24/38

(52) U.S. Cl. CPC H01R 13/631; H01R 13/187; H01R 13/64; H01R 24/38

(57) ABSTRACT

A coaxial connector is to be connected to a mating coaxial connector and includes an inner conductor and an outer conductor surrounding an outer peripheral side of the inner conductor. At least one of the inner conductor and the outer conductor includes a tube portion to be connected to a mating terminal of the mating coaxial connector. The tube portion is connected to the mating terminal with the mating terminal arranged on an inner peripheral side or an outer peripheral side of the tube portion. A part facing the mating terminal, out of a tip peripheral edge of the tube portion, has an interference avoiding surface inclined toward a side away from the mating terminal toward a tip side of the tube portion.

### TECHNICAL FIELD

The present disclosure relates to a coaxial connector and a coaxial connector connection structure.

### BACKGROUND

Patent Document 1 discloses a coaxial connector assembly including a first coaxial connector, a second coaxial connector and a third coaxial connector. Patent Document 1 discloses that floating structures relatively movable in an axial direction and a radial direction are formed between the first and second coaxial connectors and between the second and third coaxial connectors.

### PRIOR ART DOCUMENT

### Patent Document

Patent Document 1: JP 2020-047360 A

### SUMMARY OF THE INVENTION

### Problems to be Solved

If a deviation in the radial direction increases between a pair of the coaxial connectors, the other coaxial connector is more inclined with respect to one coaxial connector. In this case, the both coaxial connectors possibly interfere with each other.

Accordingly, the present disclosure aims to make it difficult for a coaxial connector to interfere with a mating coaxial connector even if the coaxial connector is inclined with respect to a center axis of the mating coaxial connector.

### Means to Solve the Problem

The present disclosure is directed to a coaxial connector to be connected to a mating coaxial connector, the coaxial connector being provided with an inner conductor and an outer conductor surrounding an outer peripheral side of the inner conductor, at least one of the inner conductor and the outer conductor including a tube portion to be connected to a mating terminal of the mating coaxial connector, the tube portion being connected to the mating terminal with the mating terminal arranged on an inner peripheral side or an outer peripheral side of the tube portion, and a part facing the mating terminal, out of a tip peripheral edge of the tube portion, having an interference avoiding surface inclined toward a side away from the mating terminal toward a tip side of the tube portion.

### Effect of the Invention

According to the present disclosure, it can be made difficult for a coaxial connector to interfere with a mating coaxial connector even if the coaxial connector is inclined with respect to a center axis of the mating coaxial connector.

### BRIEF DESCRIPTION OF THE DRAWINGS

FIG. 1 is a perspective view showing a device provided with a coaxial connector and a coaxial connector connection structure according to an embodiment.

FIG. 2 is a section along II-II of FIG. 1.

FIG. 3 is a perspective view showing the coaxial connector connection structure.

FIG. 4 is an exploded perspective view showing the connection structure.

FIG. 5 is an enlarged section of FIG. 3.

FIG. 6 is a perspective view showing the tip of the coaxial connector.

FIG. 7 is a section showing the connection structure of the obliquely connected coaxial connector.

FIG. 8 is a partial section of FIG. 7.

FIG. 9 is a section of another part of FIG. 7.

FIG. 10 is a partial section showing interference avoiding surfaces according to a modification.

### DETAILED DESCRIPTION TO EXECUTE THE INVENTION

### Description of Embodiments of Present Disclosure

First, embodiments of the present disclosure are listed and described.

The coaxial connector of the present disclosure is as follows.
(1) The coaxial connector of the present disclosure is to be connected to a mating coaxial connector and provided with an inner conductor and an outer conductor surrounding an outer peripheral side of the inner conductor, at least one of the inner conductor and the outer conductor including a tube portion to be connected to a mating terminal of the mating coaxial connector, the tube portion being connected to the mating terminal with the mating terminal arranged on an inner peripheral side or an outer peripheral side of the tube portion, and a part facing the mating terminal, out of a tip peripheral edge of the tube portion, having an interference avoiding surface inclined toward a side away from the mating terminal toward a tip side of the tube portion.

If the coaxial connector is inclined with respect to the center axis of the mating coaxial connector when the coaxial connector is connected to the mating coaxial connector, the tip peripheral edge of the tube portion possibly approaches the mating terminal. According to this coaxial connector, the part facing the mating terminal, out of the tip peripheral edge of the tube portion, is inclined toward the side away from the mating terminal toward the tip side of the tube portion. Thus, even if the tip peripheral edge of the tube portion approaches the mating terminal, contact with the mating terminal is suppressed. In this way, the coaxial connector hardly interferes with the mating coaxial connector even if the coaxial connector is inclined with respect to the center axis of the mating coaxial connector.
(2) In the coaxial connector of (1), the interference avoiding surface may annularly extend along the tip peripheral edge of the tube portion.

In this case, regardless of in which direction the coaxial connector is inclined with respect to the center axis of the mating coaxial connector, the coaxial connector hardly interferes with the mating coaxial connector.
(3) In the coaxial connector of (1) or (2), the interference avoiding surface may guide a resilient piece of the mating terminal at the tip peripheral edge of the tube portion.

In this case, the resilient piece can smoothly move to the inner peripheral side or the outer peripheral side of the tube portion by being guided by the interference avoiding surface.
(4) In the coaxial connector of any one of (1) to (3), the interference avoiding surface may be formed on one of the inner peripheral side and the outer peripheral side of the tube portion and a surface of the other of the inner peripheral side and the outer peripheral side of the tube portion may be formed into such a shape that a part having the same diameter is continuous along a center axis of the tube portion.

In this case, the interference avoiding surface can be easily formed, for example, by chamfering an end part of the tube portion.
(5) In the coaxial connector of any one of (1) to (4), the interference avoiding surface may be formed on one of the inner peripheral side and the outer peripheral side of the tube portion and a surface of the other of the inner peripheral side and the outer peripheral side of the tube portion may be formed into a shape inclined toward the same side as inclination of the interference avoiding surface.

In this case, the interference avoiding surface can be easily formed, for example, by bending an end part of the tube portion.
(6) In the coaxial connector of (5), a slit dividing the interference avoiding surface may be formed in the tip peripheral edge of the tube portion.

In this way, the interference avoiding surface divided by the slit can be easily formed on the entire tip peripheral edge of the tube portion.
(7) In the coaxial connector of (6), a width of the slit may be smaller than a width of a resilient piece of the mating terminal.

In this way, the resilient piece is smoothly guided to the inner peripheral side or the outer peripheral side of the tube portion without being fit into the slit.
(8) In the coaxial connector of any one of (1) to (7), the inner conductor may include an inner conductor tube portion serving as the tube portion, the mating terminal may be inserted into the inner conductor tube portion, and an inner peripheral part of a tip peripheral edge of the inner conductor tube portion may be formed with an inner interference avoiding surface serving as the interference avoiding surface.

When the mating terminal is inserted into the inner conductor tube portion, the inner peripheral part of the tip peripheral edge of the inner conductor tube portion is thought to easily interfere with the mating terminal if the inner conductor is largely inclined with respect to the mating terminal. If the inner interference avoiding surface serving as the interference avoiding surface is formed on the inner peripheral part of the tip peripheral edge of the inner conductor tube portion, the inner peripheral part of the tip peripheral edge of the inner conductor tube portion hardly interferes with the mating terminal even if the inner conductor is largely inclined with respect to the mating terminal.
(9) In the coaxial connector of any one of (1) to (8), the outer conductor may include an outer conductor tube portion serving as the tube portion, the outer conductor tube portion may be inserted into the mating terminal, and an outer peripheral part of a tip peripheral edge of the outer conductor tube portion may be formed with an outer interference avoiding surface serving as the interference avoiding surface.

When the mating terminal is inserted into the outer conductor tube portion, the outer peripheral part of the tip peripheral edge of the outer conductor tube portion is thought to easily interfere with the mating terminal if the outer conductor is largely inclined with respect to the mating terminal. If the outer interference avoiding surface serving as the interference avoiding surface is formed on the outer peripheral part of the tip peripheral edge of the outer conductor tube portion, the outer peripheral part of the tip peripheral edge of the outer conductor tube portion hardly interferes with the mating terminal even if the outer conductor is largely inclined with respect to the mating terminal.

Further, a coaxial connector connection structure of the present disclosure is as follows.
(10) The coaxial connector connection structure is provided with the coaxial connector of any one of (1) to (9) and the mating coaxial connector, the mating coaxial connector including a mating inner conductor and a mating outer conductor surrounding an outer peripheral side of the mating inner conductor, the mating inner conductor including an inner resilient piece for resiliently contacting the inner conductor, and the mating outer conductor including an outer resilient piece for resiliently contacting the outer conductor.

In this case, since the mating inner conductor includes the inner resilient piece for resiliently contacting the inner conductor and the mating outer conductor includes the outer resilient piece for resiliently contacting the outer conductor, the coaxial connector can be connected to the mating coaxial connector even if the coaxial connector is inclined with respect to the mating coaxial connector by resiliently deforming the inner resilient piece and the outer resilient piece. In this case, it can be made difficult for the coaxial connector to interfere with the mating coaxial connector by the interference avoiding surface.
(11) In the coaxial connector connection structure of (10), the mating coaxial connector may include a mating dielectric located between a base end part of the mating inner conductor and a base end part of the mating outer conductor, and the mating dielectric may include an annular recess facing the coaxial connector.

In this case, since the mating dielectric is formed with the annular recess, an outer conductor tube portion hardly interferes with the mating dielectric even if the coaxial connector is connected in an inclined state to the mating coaxial connector.

### Details of Embodiment of Present Disclosure

Specific examples of a coaxial connector and a coaxial connector connection structure of the present disclosure are described below with reference to the drawings. Note that the present disclosure is not limited to these illustrations, but is represented by claims and intended to include all changes in the scope of claims and in the meaning and scope of equivalents.

### Embodiment

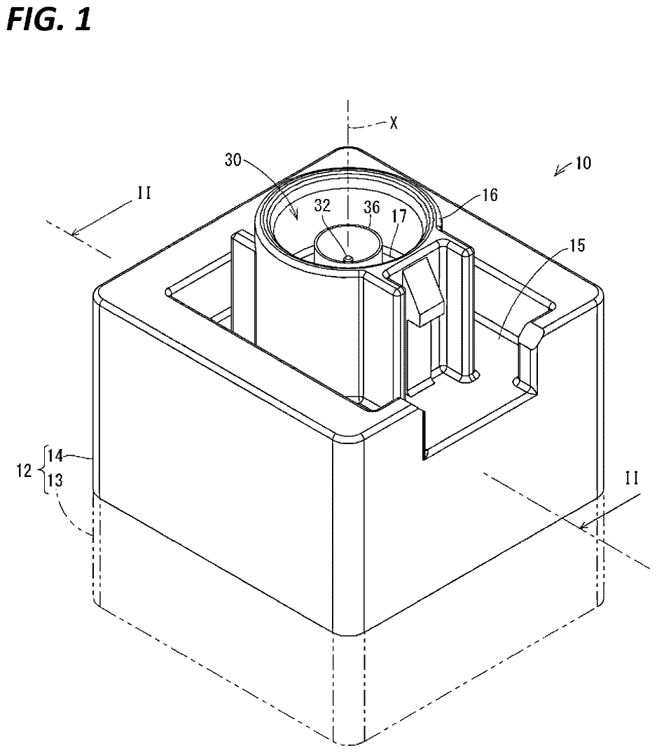

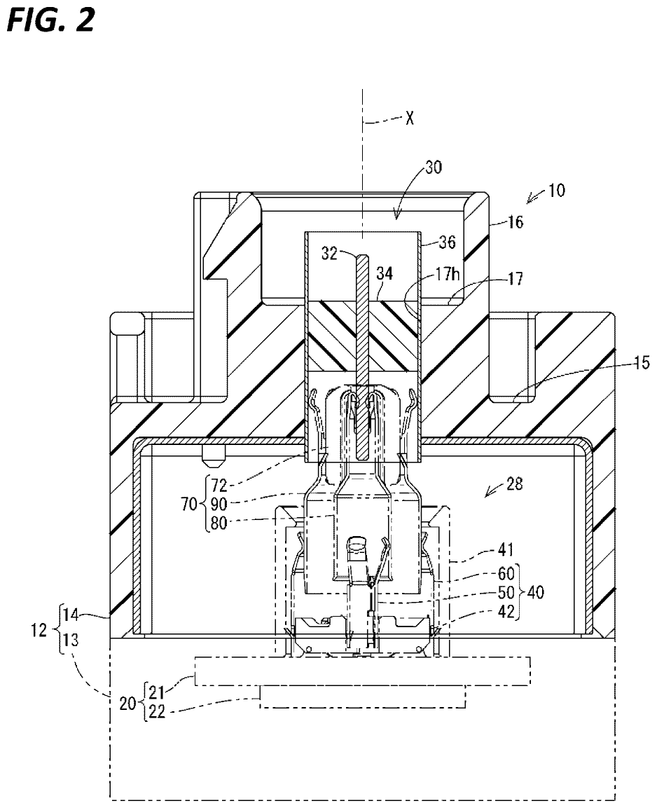

Hereinafter, a coaxial connector connection structure according to an embodiment is described. FIG. 1 is a perspective view showing a device 10 provided with a coaxial connector 70 and a coaxial connector connection structure 28. FIG. 2 is a section along II-II of FIG. 1.

### Concerning Overall Configuration of Device

The device 10 is, for example, a camera device. The camera device is, for example, an in-vehicle device. The device 10 may not be a camera device.

The device 10 is provided with a case 12, an electrical component 20 and an external connection coaxial connector 30. The electrical component 20 is accommodated in the case 12. The external connection coaxial connector 30 is a connector for connecting the electrical component 20 and an external electrical component. For example, the external connection coaxial connector 30 is a connector, to which a cable connected to the external electrical component is connected.

The case 12 is provided with a first case 13 and a second case 14. The first and second cases 13, 14 are, for example, made of resin. By uniting the first and second cases 13, 14, the case 12 in the form of a rectangular parallelepiped box for accommodating the electrical component 20 is configured. If the device 10 is a camera device, it is assumed that the first case 13 includes a lens or window for imaging, and the second case 14 includes the external connection coaxial connector 30.

More specifically, a holding tube portion 16 projects on a bottom portion 15 of the case 12. The holding tube portion 16 is a hollow cylinder and projects outward from a central part of the bottom portion 15. An inner opening of the holding tube portion 16 is open to the inside of the second case 14, and an outer opening of the holding tube portion 16 is open to the outside of the second case 14. A holding/partitioning portion 17 is formed in an intermediate part in a direction along a center axis X of the holding tube portion 16. In this embodiment, the holding/partitioning portion 17 is formed in the intermediate part in the direction along the center axis X of the holding tube portion 16 and at a position near the inner opening. The holding/partitioning portion 17 partitions between a space on the inner opening side and a space on the outer opening side in the holding tube portion 16. The holding/partitioning portion 17 is formed with a holding hole 17h, and the external connection coaxial connector 30 is inserted and held in the holding hole 17h.

The external connection coaxial connector 30 is provided with an external connection inner conductor 32, an external connection dielectric 34 and an external connection outer conductor 36.

The external connection inner conductor 32 is in the form of an elongated bar and made of an electrically conductive material such as metal. The external connection inner conductor 32 is an example of a pin-like opposite mating inner conductor to be inserted and connected to an inner conductor 80 to be described later. The external connection dielectric 34 is formed of an insulator such as resin and surrounds the external connection inner conductor 32. The external connection outer conductor 36 is made of an electrically conductive material such as metal. The external connection outer conductor 36 is formed into a tubular shape surrounding the external connection dielectric 34. The external connection outer conductor 36 is an example of an opposite mating outer conductor to be connected to an outer conductor 90.

The electrical component 20 is, for example, a mounting board having an electronic component mounted on a board. If the device 10 is a camera device, the electrical component 20 is assumed to include a circuit board 21 and an imaging element 22 mounted on the circuit board 21. The imaging element 22 faces the lens or window for imaging of the first case 13 and images an outside view by turning the lens or window. The side of the first case 13, toward which the imaging element 22 is facing, may be referred to as a front side, and the side of the second case 14 opposite to the front side may be referred to as a rear side below.

The coaxial connector connection structure 28 is incorporated into the device 10. The coaxial connector connection structure 28 is a connection structure of a board coaxial connector 40 and the coaxial connector 70.

In this embodiment, the board coaxial connector 40 is located on a surface of the circuit board 21 opposite to the imaging element 22. The board coaxial connector 40 is fixed to the circuit board 21. The board coaxial connector 40 is an example of a mating coaxial connector to be connected to the coaxial connector.

The board coaxial connector 40 is provided with a mating inner conductor 50 and a mating outer conductor 60 surrounding an outer peripheral side of the mating inner conductor 50. The board coaxial connector 40 may be further provided with a mating dielectric 42 located between the mating inner conductor 50 and the mating outer conductor 60.

The mating dielectric 42 surrounds the mating inner conductor 50. The mating dielectric 42 is formed of an insulator. The mating outer conductor 60 surrounds the mating dielectric 42. A base end part of the mating inner conductor 50 and that of the mating outer conductor 60 are fixed to the circuit board 21 by soldering or the like. In this way, the mating inner conductor 50 and the mating outer conductor 60 are electrically connected to a circuit of the circuit board 21 and fixed in a state projecting from the circuit board 21. The board coaxial connector 40 projects from the circuit board 21 toward the external connection coaxial connector 30.

The coaxial connector 70 is connected to the board coaxial connector 40. The coaxial connector 70 includes the inner conductor 80, the outer conductor 90 surrounding an outer peripheral side of the inner conductor 80 and a dielectric 72 located between the inner conductor 80 and the outer conductor 90. The dielectric 72 surrounds the inner conductor 80. The dielectric 72 is formed of an insulator. The outer conductor 90 surrounds the dielectric 72. With the mating inner conductor 50 inserted and connected to the inner conductor 80 and the outer conductor 90 inserted and connected to the mating outer conductor 60, the coaxial connector 70 is connected to the board coaxial connector 40. The coaxial connector 70 projects further toward the external connection coaxial connector 30 from the board coaxial connector 40. The coaxial connector 70 relays and connects the board coaxial connector 40 and the external connection coaxial connector 30. The coaxial connector 70 is so connected to the board coaxial connector 40 and the external connection coaxial connector 30 as to be capable of changing a posture. The coaxial connector 70 may be grasped as a relay coaxial connector.

The external connection coaxial connector 30 is provided on the side of the second case 14, i.e. on a rear side of the case 12. The coaxial connector 70 is connected to the external connection coaxial connector 30 in the case 12. A cable from outside is connected to the external connection coaxial connector 30, whereby an external electrical component as a connection destination of this cable and the electrical component 20 in the case 12 are electrically connected.

The circuit board 21 is supported at a fixed position in the case 12. In design, the position of the board coaxial connector 40 with respect to the external connection coaxial connector 30 is set to be a fixed position. However, the position of the board coaxial connector 40 with respect to the external connection coaxial connector 30 may possibly deviate from a design position within a tolerance range.

In this embodiment, an insertion amount of the coaxial connector 70 into the board coaxial connector 40 is adjustable within a range that the mating inner conductor 50 and the inner conductor 80 can be kept in electrical contact and the mating outer conductor 60 and the outer conductor 90 can be kept in electrical contact. Further, the coaxial connector 70 is insertable and connectable in an inclined state to the board coaxial connector 40 and the external connection coaxial connector 30. In this way, even if a distance of the external connection 30 from the board coaxial connector 40 varies during an assembly operation or in a completed state of the device 10, this distance change can be absorbed by adjusting the insertion amount of the coaxial connector 70 into the board coaxial connector 40. Further, even if the external connection coaxial connector 30 deviates from a position facing the board coaxial connector 40 on the same axis, this position deviation is absorbed by the coaxial connector 70 being inclined with respect to the board coaxial connector 40 and the external connection coaxial connector 30.

As the coaxial connector 70 is more inclined with respect to the board coaxial connector 40, there is a possibility that a part of the tip peripheral edge of the outer conductor 90 on the side of the circuit board 21 approaches the mating outer conductor 60 and interferes with this mating outer conductor 60. Further, there is a possibility that a part of the tip peripheral edge of the inner conductor 80 on the side of the circuit board 21 approaches the mating inner conductor 50 and interferes with the mating inner conductor 50.

For example, if the coaxial connector 70 most approaches the board coaxial connector 40 and the external connection coaxial connector 30 most deviates from the position facing the board coaxial connector 40 on the same axis within the tolerance range, the coaxial connector 70 is thought to be most inclined with respect to the board coaxial connector 40. There is a large request to avoid the interference of the coaxial connector 70 with the board coaxial connector 40 with the coaxial connector 70 most inclined with respect to the board coaxial connector 40.

Note that, assuming a relative positional relationship of the coaxial connectors 40, 70 variable within the tolerance range, the inner conductor 80 and the outer conductor 90 are designed to make reliable connection and obtain desired communication performance. Thus, only by shortening projecting lengths of the tip peripheral edges of the inner conductor 80 and the outer conductor 90, a case where it is difficult to avoid the above interference is possibly assumed.

On the premise of the connection structure of the board coaxial connector 40 and the coaxial connector 70, a configuration for avoiding the above interference is described.

### Concerning Coaxial Connector Connection Structure

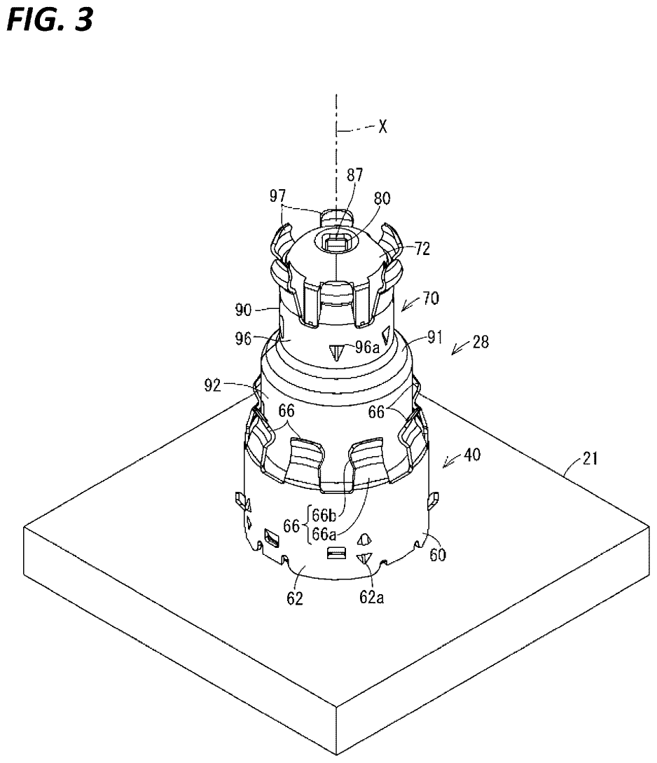

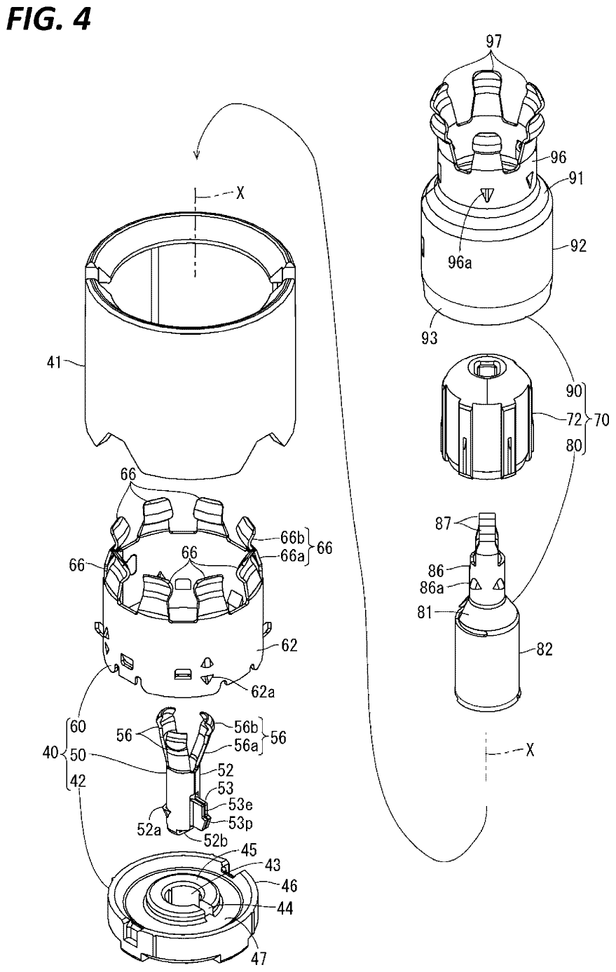

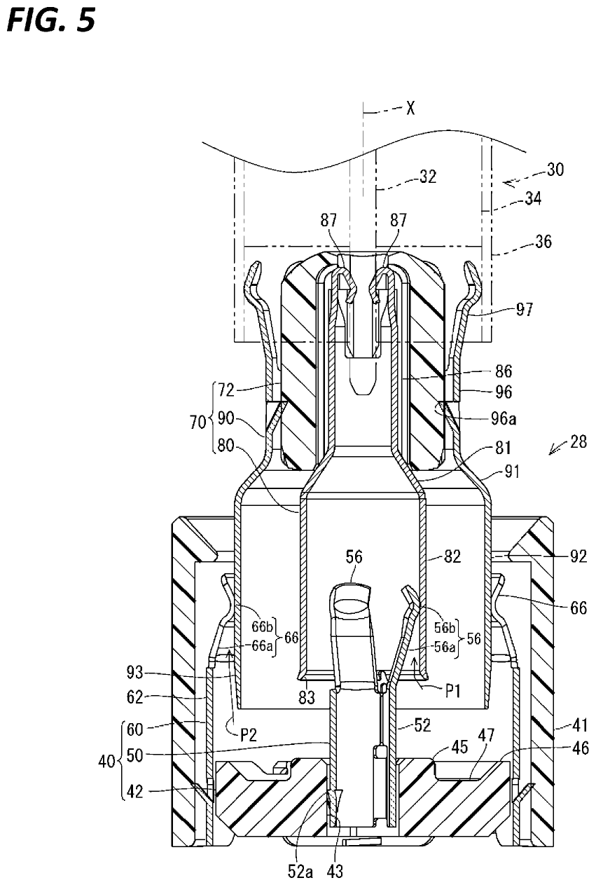

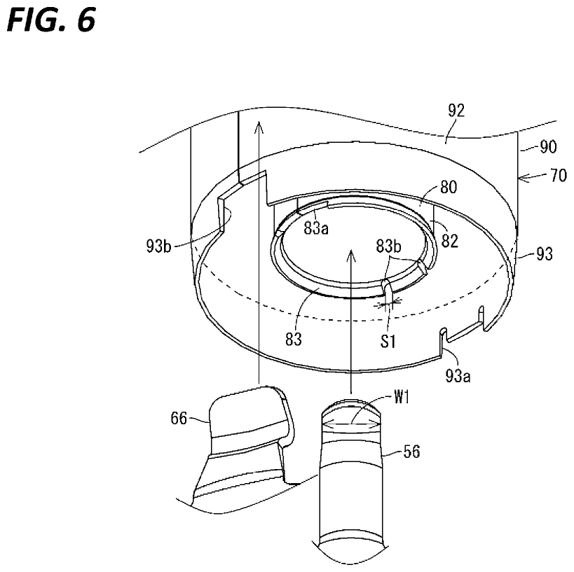

The coaxial connector connection structure 28 is more specifically described. FIG. 3 is a perspective view showing the coaxial connector connection structure 28. FIG. 4 is an exploded perspective view showing the connection structure. FIG. 5 is an enlarged section of FIG. 3. FIG. 6 is a perspective view showing the tip of the coaxial connector 70. Resilient pieces 56, 66 are partially shown in FIG. 6.

After each of the board coaxial connector 40 and the coaxial connector 70 is specifically described, a structure for avoiding the interference is more specifically described.

### Concerning Board Coaxial Connector

As described above, the board coaxial connector 40 includes the mating inner conductor 50, the mating outer conductor 60 and the mating dielectric 42.

The mating inner conductor 50 is an elongated electrically conductive member. In this embodiment, the mating inner conductor 50 is formed by press-working a metal plate. Note that a first inner conductor may be formed by cutting a metal material.

More specifically, the mating inner conductor 50 includes a mating inner conductor tube portion 52 and inner resilient pieces 56.

The mating inner conductor tube portion 52 is formed into a tubular shape, more specifically a hollow cylindrical shape. A base end part of the mating inner conductor 50 is accommodated and held in the mating dielectric 42. Note that, in the board coaxial connector 40, a tip is an end on a side where the coaxial connector 70 is connected, and a base end is an end opposite to the tip, here an end facing the circuit board 21.

A positioning piece 53 is formed to project to an outer peripheral side from a circumferential part in a base end part of the mating inner conductor tube portion 52. The positioning piece 53 is a plate-like part along a center axis of the mating inner conductor tube portion 52 and, in this embodiment, a rectangular plate-like part. The positioning piece 53 is configured by overlapping two plate-like parts. In this embodiment, the mating inner conductor tube portion 52 is formed by press-working a plate-like part into a tube. Plate-like parts project to the outer peripheral side respectively from two edge parts adjacent at a joint of the tube, and the positioning piece 53 is formed by overlapping these two plate-like parts.

A retaining projection 53p to be hooked to the bottom of a positioning groove 44 of the mating dielectric 42 is formed on a projecting end part 53e of the positioning piece 53. The retaining projection 53p is formed into a shape to be hooked to the bottom of the positioning groove 44 to make the detachment of the mating inner conductor tube portion 52 from the mating dielectric 42 toward the tip side difficult. Here, the retaining projection 53p is in the form of a triangular plate. An edge on a tip side of the mating inner conductor tube portion 52, out of the retaining projection 53p, is more inclined with respect to the center axis X than an edge on a base end side of the mating inner conductor tube portion 52, out of the retaining projection 53p. Thus, the retaining projection 53p is easily press-fit into the positioning groove 44 on the base end side of the mating inner conductor tube portion 52 and can be made difficult to come out to the tip side of the mating inner conductor tube portion 52. The positioning piece 53 and the retaining projection 53p may be omitted.

The mating inner conductor tube portion 52 may be formed with a locking piece 52a to be hooked to the inner peripheral surface of the mating dielectric 42 when being press-fit into the mating dielectric 42. A projecting piece 52b used for soldering may be provided to extend along a principal surface of the circuit board 21 on the base end of the mating inner conductor tube portion 52.

The inner resilient pieces 56 project from the tip of the mating inner conductor tube portion 52. In this embodiment, a plurality of (here, three) inner resilient pieces 56 extend from the tip of the mating inner conductor tube portion 52 while being spaced apart in a circumferential direction. Preferably, the plurality of inner resilient pieces 56 are located at equal intervals around the center axis X of the mating inner conductor tube portion 52.

The inner resilient piece 56 includes an inclined portion 56a inclined outward from the tip of the mating inner conductor tube portion 52 and a curved portion 56b connected to a tip part of the inclined portion 56a and having a curved shape convex outward.

If the plurality of inner resilient pieces 56 are inserted into the inner conductor 80, outward facing top parts of the curved portions 56b are resiliently pressed against the inner peripheral surface of the inner conductor 80 while the inclined portions 56a are resiliently deformed inward. In this way, the inner resilient pieces 56 resiliently contact the inner conductor 80 and the mating inner conductor 50 is kept in a state electrically connected to the inner conductor 80.

Note that the number of the resilient pieces may be two, four or more.

The mating dielectric 42 is made of resin or the like into a disk shape. A maximum thickness of the mating dielectric 42 is smaller than a length of the mating inner conductor tube portion 52. The mating dielectric 42 is, for example, a molded resin component.

An insertion hole 43, into which the base end part of the mating inner conductor 50, more specifically the base end part of the mating inner conductor tube portion 52, is inserted, is formed in a center of the mating dielectric 42. Further, the positioning groove 44 is formed, into which the positioning piece 53 is fit. The positioning groove 44 is in the form of a groove recessed toward an outer peripheral side from a circumferential part of the insertion hole 43 and extending along the center axis X.

By inserting the mating inner conductor tube portion 52 into the insertion hole 43, the mating inner conductor 50 is inserted and held in the mating dielectric 42. Preferably, the mating inner conductor tube portion 52 is press-fit and held in the insertion hole 43.

If a mating inner conductor is a cutting component, the mating inner conductor is easily firmly held in a mating dielectric by the above press-fit structure. If the mating inner conductor 50 is a component formed by press-working a metal plate, the positioning piece 53 is fit into the positioning groove 44 to enhance holding strength. The inner peripheral surface of the positioning groove 44 clamps the positioning piece 53, whereby it becomes easier to firmly hold the mating inner conductor 50 by the mating dielectric 42.

Further, the retaining projection 53p of the positioning piece 53 is hooked to bite into the bottom of the positioning groove 44, whereby the mating inner conductor 50 is less likely to come out from the mating dielectric 42 and the mating inner conductor 50 is more firmly held.

Further, a holding annular protrusion 45 annularly projecting toward the tip side of the mating inner conductor 50 is formed in a part of the mating dielectric 42 surrounding the insertion hole 43. The holding annular protrusion 45 holds the mating inner conductor tube portion 52, whereby the mating inner conductor 50 is more firmly held and the mating inner conductor 50 is hardly inclined with respect to the mating dielectric 42.

The outer peripheral surface of the mating dielectric 42 is formed into a short cylindrical surface insertable into an inner peripheral part of the mating outer conductor 60. An outer peripheral annular protrusion 46 annularly projecting toward the tip side of the mating inner conductor 50 is formed in an outer peripheral part of the mating dielectric 42 on the side of the mating outer conductor 60. The outer peripheral surface of the mating dielectric 42 is formed to be wide in the direction of the center axis X by the outer peripheral annular protrusion 46. Thus, the outer peripheral surface of the mating dielectric 42 can face the inner peripheral surface of the mating outer conductor 60 in a wide area. In this way, it is easy to firmly hold the mating dielectric 42 with respect to the mating outer conductor 60 and the mating outer conductor 60 is hardly inclined with respect to the mating dielectric 42. In this way, a coaxial positional relationship of the mating inner conductor 50 and the mating outer conductor 60 is easily kept.

An annular recess 47 recessed between the holding annular protrusion 45 on the inner peripheral part of the mating dielectric 42 and the outer peripheral annular protrusion 46 on the outer peripheral part is formed in a part facing the coaxial connector 70, out of the mating dielectric 42.

If the tip peripheral edge of the outer conductor 90 excessively approaches the mating dielectric 42 with the coaxial connector 70 largely inclined with respect to the board coaxial connector 40, the tip peripheral edge can enter the annular recess 47.

The mating outer conductor 60 is made of an electrically conductive material such as metal and surrounds the mating dielectric 42. Thus, the mating dielectric 42 is a tubular member interposed between the mating inner conductor 50 and the mating outer conductor 60. The mating outer conductor 60 is, for example, formed, such as by press-working a metal plate.

In this embodiment, the mating outer conductor 60 includes a mating outer conductor tube portion 62 and outer resilient pieces 66 projecting from the tip of the mating outer conductor tube portion 62.

The mating outer conductor tube portion 62 is formed into a tubular shape in which the mating dielectric 42 can be arranged, more specifically a hollow cylindrical shape. The mating dielectric 42 is accommodated and held in a base end part of the mating outer conductor tube portion 62.

The mating outer conductor tube portion 62 may be formed with locking pieces 62a to be hooked to the outer peripheral surface of the mating dielectric 42 when the mating dielectric 42 is press-fit.

The outer resilient pieces 66 project from the tip of the mating outer conductor tube portion 62. In this embodiment, a plurality of (here, eight) outer resilient pieces 66 extend from the tip of the mating outer conductor tube portion 62 while being spaced apart in a circumferential direction. Preferably, the plurality of outer resilient pieces 66 are located at equal intervals around a center axis X of the mating outer conductor tube portion 62.

The outer resilient piece 66 includes an inclined portion 66a inclined inward from the tip of the mating outer conductor tube portion 62 and a curved portion 66b connected to a tip part of the inclined portion 66a and having a curved shape convex inward.

If the plurality of outer resilient pieces 66 are externally fit to the outer conductor 90, inward facing top parts of the curved portions 66b are resiliently pressed against the outer peripheral surface of the outer conductor 90 while the inclined portions 66a are resiliently deformed outward. In this way, the outer resilient pieces 66 resiliently contact the outer conductor 90 and the mating outer conductor 60 is kept in a state electrically connected to the outer conductor 90.

Note that the number of the resilient pieces may be seven or less or nine or more.

In the direction of the center axis X, a length of the mating outer conductor tube portion 62 is larger than a thickness of the mating dielectric 42. Further, in this embodiment, the length of the mating outer conductor tube portion 62 is larger than that of the mating inner conductor 50. Further, the base end of the outer resilient piece 66 is located more away from the mating dielectric 42 than that of the inner resilient piece 56. Furthermore, the tip of the outer resilient piece 66 is located more away from the mating dielectric 42 than that of the inner resilient piece 56. However, the curved portions 56b, 66b can contact the inner conductor 80 or the outer conductor 90 at the same position in the center axis X.

The board coaxial connector 40 may be surrounded by a tubular connector holder 41. The connector holder 41 is a member made of resin or the like and functions to suppress contact with other members by surrounding the board coaxial connector 40.

### Concerning Coaxial Connector

As described above, the coaxial connector 70 is provided with the inner conductor 80, the outer conductor 90 and the dielectric 72.

The inner conductor 80 is an elongated electrically conductive member. In this embodiment, the inner conductor 80 is formed by press-working a metal plate. More specifically, the inner conductor 80 includes an inner conductor tube portion 82 and an inner conductor extended tube portion 86.

The inner conductor tube portion 82 is formed into a tubular shape, more specifically a hollow cylindrical shape. An opening end of the inner conductor tube portion 82 is facing toward the board coaxial connector 40. The inner conductor tube portion 82 is a part to be connected to the mating inner conductor 50.

More specifically, the inner conductor tube portion 82 is a tube elongated along the center axis X. An inner diameter of the inner conductor tube portion 82 is smaller than an outer diameter of a virtual circle connecting the top parts of the plurality of inner resilient pieces 56. The plurality of inner resilient pieces 56 can resiliently contact the inner peripheral surface of the inner conductor tube portion 82 while being resiliently deformed inward.

In the direction of the center axis X, the inner conductor tube portion 82 is longer than the inner resilient pieces 56. In the direction of the center axis X, the mating inner conductor 50 and the inner conductor 80 can be connected by bringing the top parts of the curved portions 56b of the inner resilient pieces 56 into contact with the inner peripheral surface of the inner conductor tube portion 82 at arbitrary positions. In this way, position deviations of the mating inner conductor 50 and the inner conductor 80 in the direction of the center axis X can be dealt with.

The inner conductor extended tube portion 86 is located on a side opposite to the board coaxial connector 40 with respect to the inner conductor tube portion 82. In this embodiment, the inner conductor extended tube portion 86 is thinner than the inner conductor tube portion 82. The inner conductor extended tube portion 86 is connected to the inner conductor tube portion 82 via a tapered portion 81. The tapered portion 81 is a part having a tapered shape gradually thinned from the inner conductor tube portion 82 toward the inner conductor extended tube portion 86. An inner conductor extended tube portion may be connected to an inner conductor tube portion via a step portion.

The inner conductor extended tube portion 86 may include resilient pieces 87 projecting toward the tip side. The resilient piece 87 is configured to be resiliently deformable in an in-out direction. The external connection inner conductor 32 is inserted between two resilient pieces 87 from the tip sides of the two resilient pieces 87. The external connection inner conductor 32 is sandwiched by the two resilient pieces 87, whereby the inner conductor 80 is connected to the external connection inner conductor 32.

The inner conductor extended tube portion 86 may be formed with partial locking pieces 86a lockable to the dielectric 72.

The dielectric 72 is made of resin or the like. The dielectric 72 is, for example, a molded resin component.

The dielectric 72 is formed into a tubular shape capable of accommodating at least a part of the inner conductor 80. In this embodiment, the dielectric 72 is formed into a hollow cylindrical shape. The inner conductor extended tube portion 86 is accommodated into the dielectric 72. The internal space of the inner conductor extended tube portion 86 is formed in such a size that a base end part of the inner conductor extended tube portion 86 can be press-fit and held therein and the resilient pieces 87 can be allowed to be resiliently deformed in the in-out direction.

One end of the dielectric 72 contacts the tapered portion 81, whereby the dielectric 72 can be positioned with respect to the inner conductor 80. The inner conductor tube portion 82 extends further toward the board coaxial connector 40 than the dielectric 72.

The outer conductor 90 is arranged on an outer peripheral side of the dielectric 72. The outer conductor 90 is made of an electrically conductive material such as metal and surrounds the dielectric 72. The outer conductor 90 is, for example, formed by press-working a metal plate.

The outer conductor 90 includes an outer conductor tube portion 92 and an outer conductor extended tube portion 96.

The outer conductor tube portion 92 is formed into a tubular shape, more specifically a hollow cylindrical shape. An opening end of the outer conductor tube portion 92 is facing toward the board coaxial connector 40. The outer conductor tube portion 92 is a part to be connected to the mating outer conductor 60.

The outer conductor tube portion 92 is located on an outer peripheral side of the inner conductor tube portion 82 while being spaced apart from the inner conductor tube portion 82. An outer diameter of the outer conductor tube portion 92 is larger than an outer diameter of a virtual circle connecting the top parts of the plurality of outer resilient pieces 66. The plurality of outer resilient pieces 66 can resiliently contact the outer peripheral surface of the outer conductor tube portion 92 while being resiliently deformed outward.

In the direction of the center axis X, the outer conductor tube portion 92 is longer than the outer resilient pieces 66. In the direction of the center axis X, the mating outer conductor 60 and the outer conductor 90 can be connected by bringing the top parts of the curved portions 66b of the outer resilient pieces 66 into contact with the outer peripheral surface of the outer conductor tube portion 92 at arbitrary positions. In this way, position deviations of the mating outer conductor 60 and the outer conductor 90 in the direction of the center axis X can be dealt with.

The outer conductor extended tube portion 96 is located on a side opposite to the board coaxial connector 40 with respect to the outer conductor tube portion 92. In this embodiment, the outer conductor extended tube portion 96 is thinner than the outer conductor tube portion 92. The outer conductor extended tube portion 96 is connected to the outer conductor tube portion 92 via a tapered portion 91. The tapered portion 91 is a part having a tapered shape gradually thinned from the outer conductor tube portion 92 toward the outer conductor extended tube portion 96. An outer conductor extended tube portion may be connected to an outer conductor tube portion via a step portion.

The outer conductor extended tube portion 96 may include resilient pieces 97 projecting toward the tip side. The resilient piece 97 is configured to be resiliently deformable in the in-out direction. The external connection outer conductor 36 is externally fit to the outer peripheries of the plurality of resilient pieces 97 from the tip sides of the plurality of resilient pieces 97. The outer conductor 90 is connected to the external connection outer conductor 36 by resiliently pressing the plurality of resilient pieces 97 against the inner peripheral surface of the external connection outer conductor 36.

The outer conductor extended tube portion 96 may be formed with partial locking pieces 96a lockable to the dielectric 72.

### Concerning Configuration for Interference Avoidance

At least one of the inner conductor 80 and the outer conductor 90 includes the tube portion 82, 92, to which a mating terminal of the board coaxial connector 40 is connected. In this embodiment, the mating inner conductor 50 of the board coaxial connector 40 is an example of the mating terminal and the mating outer conductor 60 is also an example of the mating terminal.

The inner conductor 80 includes the inner conductor tube portion 82 as the tube portion. The inner conductor tube portion 82 is connected to the mating inner conductor 50 with the mating inner conductor 50 serving as the mating terminal arranged on an inner peripheral side of the inner conductor tube portion 82.

The outer conductor 90 includes the outer conductor tube portion 92 as the tube portion. The outer conductor tube portion 92 is connected to the mating outer conductor 60 with the mating outer conductor 60 serving as the mating terminal arranged on an outer peripheral side of the outer conductor tube portion 92.

Out of the tip peripheral edge of the tube portion 82, 92, a part facing the mating inner conductor 50 or the mating outer conductor 60 serving as the mating terminal has an interference avoiding surface 83, 93. The interference avoiding surface 83, 93 is formed into a surface inclined toward a side away from the mating inner conductor 50 or the mating outer conductor 60 serving as the mating terminal toward the tip side of the tube portion 82, 92.

The interference avoiding surface 83 of the inner conductor tube portion 82 is focused and described. The inner conductor tube portion 82 is located closer to the mating inner conductor 50 than the mating outer conductor 60 between the mating inner conductor 50 and the mating outer conductor 60. Thus, if the coaxial connector 70 is inclined with respect to the board coaxial connector 40, the tip peripheral edge of the inner conductor tube portion 82 more easily contacts the mating inner conductor 50 than the mating outer conductor 60.

Accordingly, the interference avoiding surface 83 is formed on an inner peripheral part facing toward the inner resilient pieces 56, out of the tip peripheral edge of the inner conductor tube portion 82. Further, the interference avoiding surface 83 is formed on a surface inclined toward a side away from the inner resilient pieces 56 toward the tip side of the inner conductor tube portion 82. In other words, the interference avoiding surface 83 is formed to be inclined outward toward the tip side of the inner conductor tube portion 82. The interference avoiding surface 83 may be called an inner interference avoiding surface 83.

The interference avoiding surface 83 preferably annularly extends along the tip peripheral edge of the inner conductor tube portion 82. In this case, regardless of in which direction the inner conductor tube portion 82 is inclined with respect to the mating inner conductor 50, the interference of the inner conductor tube portion 82 and the mating inner conductor 50 is easily avoided.

The interference avoiding surface 83 may be formed with such a recess 83a as not to reach the base end of the interference avoiding surface 83. Such a recess 83a as not to reach the base end of the interference avoiding surface 83 does not deny the continuity of the interference avoiding surface 83 annularly extending along the tip peripheral edge of the inner conductor tube portion 82.

The interference avoiding surface 83 may be formed with slits 83b for facilitating working. The slits 83b smaller than a width W1 of the inner resilient pieces 56 (see FIG. 6) do not deny the continuity of the interference avoiding surface 83 annularly extending along the tip peripheral edge of the inner conductor tube portion 82.

It is not essential that the interference avoiding surface 83 annularly extends along the tip peripheral edge of the inner conductor tube portion 82. For example, if a direction of inclination of the coaxial connector 70 with respect to the board coaxial connector 40 is already determined, an interference avoiding surface may be formed on a partial location capable of interfering with a mating inner conductor by the inclination, out of the tip peripheral edge of the inner conductor tube portion 82.

The interference avoiding surface 83 is preferably formed at a position for guiding the inner resilient pieces 56 on the tip peripheral edge of the inner conductor tube portion 82. For example, if the connection postures of the coaxial connector 70 and the board coaxial connector 40 are fixed around the center axis X, the interference avoiding surface 83 may be formed at the same position as the inner resilient pieces around the center axis X.

If the interference avoiding surface 83 entirely annularly extends along the tip peripheral edge of the inner conductor tube portion 82, the interference avoiding surface 83 can guide the inner resilient pieces 56, regardless of the connection postures of the coaxial connector 70 and the board coaxial connector 40 around the center axis X.

The interference avoiding surface 83 only has to be a surface formed on the inner peripheral part of the tip peripheral edge of the inner conductor tube portion 82, and a formation method thereof does not matter. For example, the interference avoiding surface 83 may be formed by scraping the inner peripheral part of the tip peripheral edge of the inner conductor tube portion 82, rolling the tip peripheral edge of the inner conductor tube portion 82 to be thinner toward the tip, press-working to bend the tip peripheral edge of the inner conductor tube portion 82 or combining these working methods.

In this embodiment, the interference avoiding surface 83 is formed by press-working to bend the tip peripheral edge of the inner conductor tube portion 82. In this case, both the inner peripheral surface and the outer peripheral surface of the tip peripheral edge of the inner conductor tube portion 82 are bent in the same direction. Thus, out of the inner conductor tube portion 82, an outer peripheral surface part on a side opposite to the interference avoiding surface 83 is formed into a shape inclined along the interference avoiding surface 83 on an outer peripheral side of the interference avoiding surface 83.

If the interference avoiding surface 83 is formed by press-working to bend the tip peripheral edge of the inner conductor tube portion 82, it is easy to largely bend the interference avoiding surface 83.

The interference avoiding surface 93 of the outer conductor tube portion 92 is focused and described.

The outer conductor tube portion 92 is located closer to the mating outer conductor 60 than the mating inner conductor 50 between the mating inner conductor 50 and the mating outer conductor 60. Thus, if the coaxial connector 70 is inclined with respect to the board coaxial connector 40, the tip peripheral edge of the outer conductor tube portion 92 more easily contacts the mating outer conductor 60 than the mating inner conductor 50.

Accordingly, the interference avoiding surface 93 is formed on an outer peripheral part facing toward the outer resilient pieces 66, out of the tip peripheral edge of the outer conductor tube portion 92. Further, the interference avoiding surface 93 is formed into a surface inclined toward a side away from the outer resilient pieces 66 toward the tip side of the outer conductor tube portion 92. In other words, the interference avoiding surface 93 is formed to be inclined inward toward the tip side of the outer conductor tube portion 92. The interference avoiding surface 93 may be called an outer interference avoiding surface 93.

The interference avoiding surface 93 preferably annularly extends along the tip peripheral edge of the outer conductor tube portion 92. In this case, regardless of in which direction the outer conductor tube portion 92 is inclined with respect to the mating outer conductor 60, the interference of the outer conductor tube portion 92 and the mating outer conductor 60 is easily avoided.

The interference avoiding surface 93 may be formed with such recesses 93a, 93b as not to reach the base end of the interference avoiding surface 93. Such recesses 93a, 93b as not to reach the base end of the interference avoiding surface 93 do not deny the continuity of the interference avoiding surface 93 annularly extending along the tip peripheral edge of the outer conductor tube portion 92.

It is not essential that the interference avoiding surface 93 annularly extends along the tip peripheral edge of the outer conductor tube portion 92. For example, if a direction of inclination of the coaxial connector 70 with respect to the board coaxial connector 40 is determined, an interference avoiding surface may be formed on a partial location capable of interfering with a mating outer conductor by the inclination, out of the tip peripheral edge of the outer conductor tube portion 92.

The interference avoiding surface 93 is preferably formed at a position for guiding the outer resilient pieces 66 on the tip peripheral edge of the outer conductor tube portion 92. For example, if the connection postures of the coaxial connector 70 and the board coaxial connector 40 are fixed around the center axis X, the interference avoiding surface 93 may be formed at the same position as the outer resilient pieces around the center axis X.

If the interference avoiding surface 93 annularly extends along the tip peripheral edge of the outer conductor tube portion 92, the interference avoiding surface 93 can guide the outer resilient pieces 66 regardless of the connection postures of the coaxial connector 70 and the board coaxial connector 40 around the center axis X.

The interference avoiding surface 93 only has to be a surface formed on the outer peripheral part of the tip peripheral edge of the outer conductor tube portion 92, and a formation method thereof does not matter. For example, the interference avoiding surface 93 may be formed by scraping the outer peripheral part of the tip peripheral edge of the outer conductor tube portion 92, rolling the tip peripheral edge of the outer conductor tube portion 92 to be thinner toward the tip or press-working (e.g. drawing) to bend the tip peripheral edge of the outer conductor tube portion 92.

In this embodiment, the interference avoiding surface 93 is formed by scraping the outer peripheral part of the tip peripheral edge of the outer conductor tube portion 92. The working to form the interference avoiding surface 93 by scraping the outer peripheral part of the tip peripheral edge of the outer conductor tube portion 92 is working called chamfering.

In this case, out of the outer conductor tube portion 92, an inner peripheral part on a side opposite to the interference avoiding surface 93 is formed into such a shape that a part having the same diameter is continuous along the center axis X of the outer conductor tube portion 92. That is, the inner peripheral surface of the outer conductor tube portion 92 is shaped to have an unchanged initial shape when the outer conductor tube portion 92 is worked into a circular shape.

If the inner peripheral part on the side opposite to the interference avoiding surface 93, out of the outer conductor tube portion 92, is formed into such a shape that the part having the same diameter is continuous along the center axis X, a distance between the outer conductor tube portion 92 and the center axis X is easily kept constant. In this way, a distance change between the inner and outer conductors can be reduced and communication performance in the coaxial connector connection structure 28 is easily kept good.

As an angle of the interference avoiding surface 83, 93 with respect to the center axis X increases, the interference of the tip peripheral edge of the tube portion 82, 92 is more easily avoided. Further, as a length of the interference avoiding surface 83, 93 in the direction along the center axis X increases, the interference of the tip peripheral edge of the tube portion 82, 92 is more easily avoided.

In this embodiment, the inclination of the interference avoiding surface 83 with respect to the center axis X is larger than that of the interference avoiding surface 93 with respect to the center axis X. Conversely, the length of the interference avoiding surface 83 in the direction along the center axis X is shorter than that of the interference avoiding surface 93 in the direction along the center axis X.

In this way, each of the tip peripheral edges of the tube portions 82, 92 is formed to have an appropriate interference avoiding shape.

The inclinations of the interference avoiding surfaces 83, 93 with respect to the center axis X and the lengths thereof in the direction along the center axis X may be set to such values that the interference of the both coaxial connectors 40, 70 can be avoided, in view of a possible maximum angle of inclination of the coaxial connector 70 with respect to the board coaxial connector 40.

### Connection Structure During Connector Connecting Operation and in Inclined State

If the coaxial connector 70 is connected to the board coaxial connector 40, the plurality of inner resilient pieces 56 of the mating inner conductor 50 are inserted into the inner conductor tube portion 82 and the outer conductor tube portion 92 is inserted inside the plurality of outer resilient pieces 66 of the mating outer conductor 60.

At this time, the plurality of inner resilient pieces 56 contact the interference avoiding surface 83 of the inner conductor tube portion 82, whereby the plurality of inner resilient pieces 56 are smoothly guided to the inner peripheral surface on a back side of the inner conductor tube portion 82 while being displaced to the inner peripheral side (see an arow P1 of FIG. 5). Further, the plurality of outer resilient pieces 66 contact the interference avoiding surface 93 of the outer conductor tube portion 92, whereby the plurality of outer resilient pieces 66 are smoothly guide to the outer peripheral surface on a back side of the outer conductor tube portion 92 while being displaced to the outer peripheral side (see an arow P2 of FIG. 5).

In this way, it is suppressed that the plurality of inner resilient pieces 56 are hooked to the tip peripheral edge of the inner conductor tube portion 82 and the plurality of outer resilient pieces 66 are hooked to the tip peripheral edge of the outer conductor tube portion 92, and the coaxial connector 70 is smoothly connected to the board coaxial connector 40.

If the coaxial connector 70 is properly connected to the board coaxial connector 40, the center axis X of the board coaxial connector 40 and the center axis X of the coaxial connector 70 coincide and a distance between the board coaxial connector 40 and the coaxial connector 70 is kept at a predetermined design distance (see FIG. 5).

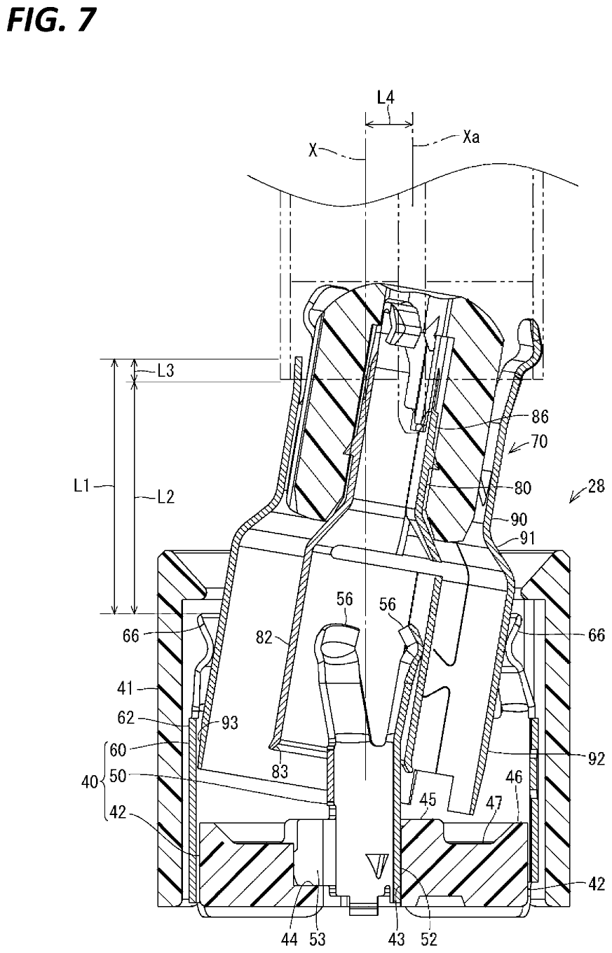

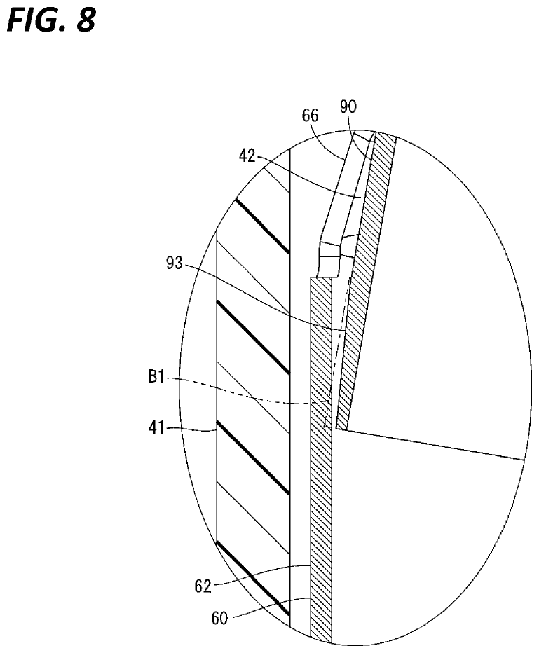

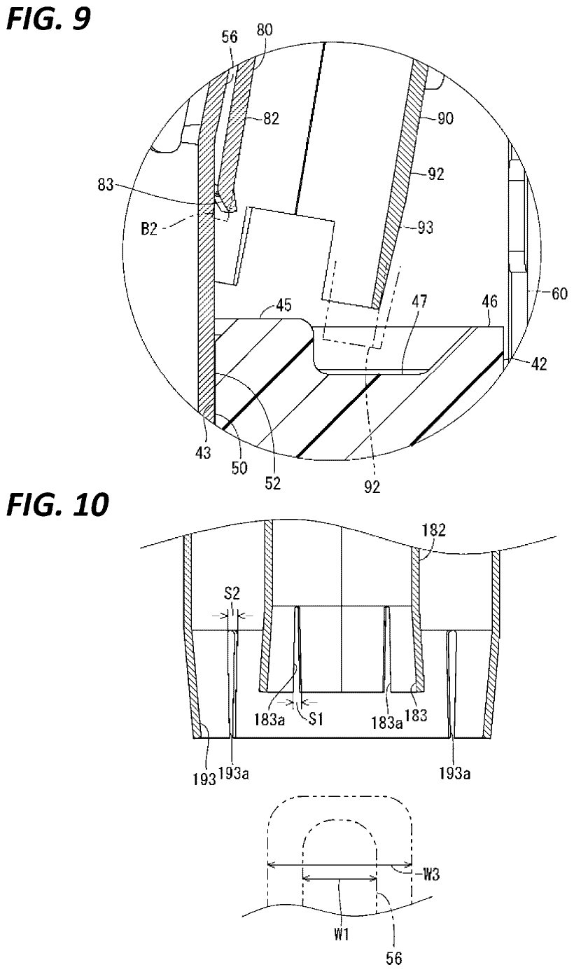

FIG. 7 is a section of the connection structure 28 when the coaxial connector 70 most approaches the board coaxial connector 40 and the external connection coaxial connector 30 most deviates from the position facing the board coaxial connector 40 on the same axis with the tolerance range. FIGS. 8 and 9 are partial sections of FIG. 7.

In FIG. 7, a distance L2 of the coaxial connector 70 from the board coaxial connector 40 is smaller than an initial design distance L1 by a distance L3. Further, a center axis Xa of the coaxial connector 70 is separated from the center axis X of the board coaxial connector 40 by a distance L4.

In this case, out of the inner conductor 80, a part of the tip peripheral edge on the side of the circuit board 21 approaches the mating inner conductor 50. Further, out of the outer conductor 90, a part of the tip peripheral edge on the side of the circuit board 21 approaches the mating outer conductor 60. Thus, if the tip peripheral edges of the inner conductor tube portion 82 and the outer conductor tube portion 92 have the initial shape having no interference avoiding surface, there is a possibility that these respectively contact the outer conductor 90 or the inner conductor 80 (see parts B1, B2 shown by two-dot chain lines in FIGS. 8 and 9).

Since each of the inner conductor tube portion 82 and the outer conductor tube portion 92 is formed with the interference avoiding surface 83, 93 in this embodiment, the contact of the tip peripheral edges of the inner tube portion 82 and the outer conductor tube portion 92 with the outer conductor 90 or the inner conductor 80 is effectively avoided.

Further, the inner conductor tube portion 82 possibly more approaches the mating dielectric 42 within the tolerance range. In this case, the tip peripheral edge of the inner conductor tube portion 82 can enter the annular recess 47 of the mating dielectric 42. In this way, the interference of the inner conductor tube portion 82 and the mating dielectric 42 is also avoided.

Note that, to increase avoidance amounts of the interference avoiding surfaces 83, 93, an inner conductor tube portion 182 and an outer conductor tube portion 192 according to a modification shown in FIG. 10 may be adopted. That is, each of the inner conductor tube portion 182 and the outer conductor tube portion 192 is formed with slits 183a, 193a along the center axis X. At least one slit 183a, 193a may be provided in each of the inner conductor tube portion 182 and the outer conductor tube portion 192. A plurality of the slits 183a, 193a may be provided in each of the inner conductor tube portion 182 and the outer conductor tube portion 192 and, in this case, may be provided at equal intervals in the circumferential direction. The numbers, widths and lengths of the slits 183a, 193a may be so set as not to deform the inner conductor tube portion 182 and the outer conductor tube portion 192 at the time of connection.

In the inner conductor tube portion 182, the tip peripheral edge of the inner conductor tube portion 182 is widened to an outer peripheral side to widen the slits 183a. An inner peripheral part of the part widened to the outer peripheral side serves as an interference avoiding surface 183 corresponding to the interference avoiding surface 83.

In the outer conductor tube portion 192, the tip peripheral edge of the outer conductor tube portion 192 is narrowed to an inner peripheral side to narrow the slits 193a. An outer peripheral part of the part narrowed to the inner peripheral side serves as an interference avoiding surface 193 corresponding to the interference avoiding surface 93.

In these cases, since the tip peripheral edges of the inner conductor tube portion 182 and the outer conductor tube portion 192 can be widened to the outer peripheral side or narrowed to the inner peripheral side, utilizing the slits 183a, 193a, the interference avoiding surfaces 183, 193 are easily inclined at a large angle and in a wide range, with the result that the avoidance amounts for interference avoidance are easily set to be large.

Note that widths S1, S2 of the slits 183a, 193a are preferably smaller than the width W1 of the inner resilient pieces 56 and a width W3 of the outer resilient pieces 66. In this way, the inner resilient pieces 56 and the outer resilient pieces 66 can smoothly move onto the inner peripheral surface of the inner conductor tube portion 182 or the outer peripheral surface of the outer conductor tube portion 192 without entering the slits 183a, 193a.

### Effects, Etc

According to the coaxial connector 70 and the coaxial connector connection structure 28 configured as described above, the part facing the mating inner conductor 50 or the mating outer conductor 60 as the mating terminal, out of the tip peripheral edge of the tube portion 82, 92, is inclined toward the side away from the mating inner conductor 50 or the mating outer conductor 60 toward the tip side of the tube portion 82, 92. Thus, even if the tip peripheral edge of the tube portion 82, 92 approaches the mating inner conductor 50 or the mating outer conductor 60, contact with the mating inner conductor 50 or the mating outer conductor 60 is suppressed. In this way, even if the coaxial connector 70 is inclined with respect to the center axis X of the board coaxial connector 40, the coaxial connector 70 hardly interferes with the board coaxial connector 40.

Further, if the interference avoiding surfaces 83, 93 annularly extend along the tip peripheral edges of the tube portions 82, 92, the coaxial connector 70 hardly interferes with the board coaxial connector 40, regardless of in which direction the coaxial connector 70 is inclined with respect to the center axis X of the board coaxial connector 40.

Further, if the interference avoiding surface 83, 93 is formed at the position for guiding the inner resilient pieces 56 or the outer resilient pieces 66 at the tip peripheral edge of the tube portion 82, 92, the inner resilient pieces 56 or the outer resilient pieces 66 can smoothly move to the inner peripheral side or the outer peripheral side of the tube portion 82, 92 by being guided by the interference avoiding surface 83, 93.

Further, if the inner peripheral side part on the side opposite to the interference avoiding surface 93, out of the outer conductor tube portion 92, is formed into such a shape that the part having the same diameter is continuous along the center axis X of the outer conductor tube portion 92, the interference avoiding surface 93 can be easily formed, such as by chamfering the end part of the outer conductor tube portion 92.

Further, if the outer peripheral side part on the side opposite to the interference avoiding surface 83, out of the inner conductor tube portion 82, is formed into a shape inclined along the interference avoiding surface 83, the interference avoiding surface 83 is easily formed, for example, by bending the end part of the inner conductor tube portion 82.

Further, if the slits 83b, 183a, 193a dividing the interference avoiding surface 83, 93, 193 are formed in the tip peripheral edge of the inner conductor tube portion 82, 182 or the outer conductor tube portion 192, the interference avoiding surface 83, 93, 183 divided in the entire tip peripheral edge of the inner conductor tube portion 82, 182 or the outer conductor tube portion 192 can be easily formed.

Further, if the width S1, S of the slits 83b, 183a, 193a is smaller than the width W1 of the inner resilient pieces 56 or the width W2 of the outer resilient pieces 66, the inner resilient pieces 56 or the outer resilient pieces 66 are smoothly guided to the inner peripheral side of the inner conductor tube portion 82, 182 or the outer peripheral side of the outer conductor tube portion 192 without being fit into the slits 83b, 183a, 193a.

Further, the inner interference avoiding surface 83 is formed on the inner peripheral part, out of the tip peripheral edge of the inner conductor tube portion 82. Thus, the inner peripheral part, out of the tip peripheral edge of the inner conductor tube portion 82, hardly interferes with the mating inner conductor 50 even if the inner conductor 80 is largely inclined with respect to the mating inner conductor 50.

Further, the outer interference avoiding surface 93 is formed on the outer peripheral part, out of the tip peripheral edge of the outer conductor tube portion 92. Thus, the outer peripheral part, out of the tip peripheral edge of the outer conductor tube portion 92, hardly interferes with the mating outer conductor 60 even if the outer conductor 90 is largely inclined with respect to the mating outer conductor 60.

Further, according to this connection structure 28, the mating inner conductor 50 includes the inner resilient pieces 56 and the mating outer conductor 60 includes the outer resilient pieces 66. Thus, by resiliently deforming the inner resilient pieces 56 and the outer resilient pieces 66, the coaxial connector 70 can be connected to the board coaxial connector 40 even if the coaxial connector 70 is inclined with respect to the board coaxial connector 40. In this case, even if the coaxial connector 70 is inclined with respect to the board coaxial connector 40, it can be made difficult for the coaxial connector 70 to interfere with the board coaxial connector 40 by the interference avoiding surfaces 83, 93.

Further, since the mating dielectric 42 is formed with the annular recess 47, the outer conductor tube portion 92 hardly interferes with the mating dielectric 42 even if the coaxial connector 70 is connected in an inclined state to the board coaxial connector 40.

Further, since the thicknesses of the inner and outer peripheral parts of the mating dielectric 42 are ensured, the mating outer conductor 60 and the mating inner conductor 50 are firmly held with respect to the mating dielectric 42.

Note that the respective configurations described in the above embodiment and the respective modifications can be appropriately combined without technically contradicting each other.

### LIST OF REFERENCE NUMERALS

10 device
12 case
13 first case
14 second case
15 bottom portion
16 holding tube portion
17 holding/partitioning portion
17h holding hole
20 electrical component
21 circuit board
22 imaging element
28 connection structure
30 external connection coaxial connector
32 external connection inner conductor
34 external connection dielectric
36 external connection outer conductor
40 board coaxial connector (mating coaxial connector)
41 connector holder
42 mating dielectric
43 insertion hole
44 positioning groove
45 holding annular protrusion
46 outer peripheral annular protrusion
47 annular recess
50 mating inner conductor (mating terminal)
52 mating inner conductor tube portion
52a locking piece
52b projecting piece
53 positioning piece
53e projecting end part
53p retaining projection
56 inner resilient piece (resilient piece)
56a inclined portion
56b curved portion
60 mating outer conductor (mating terminal)
62 mating outer conductor tube portion
62a locking piece
66 outer resilient piece (resilient piece)
66a inclined portion
66b curved portion
70 coaxial connector
72 dielectric
80 inner conductor
81 tapered portion
82, 182 inner conductor tube portion (tube portion)
83,183 inner interference avoiding surface (interference avoiding surface)
83a recess
83b, 183a slit
86 inner conductor extended tube portion
86a locking piece
87 resilient piece
90 outer conductor
91 tapered portion
92, 192 outer conductor tube portion (tube portion)
93, 193 outer interference avoiding surface (interference avoiding surface)
93a, 93b recess
96 outer conductor extended tube portion
96a locking piece
97 resilient piece
193a slit
S1, S2 width of slit
W1, W3 width of resilient piece
X center axis

1. A coaxial connector to be connected to a mating coaxial connector, comprising:
an inner conductor; and
an outer conductor surrounding an outer peripheral side of the inner conductor,
at least one of the inner conductor and the outer conductor including a tube portion to be connected to a mating terminal of the mating coaxial connector,
the tube portion being connected to the mating terminal with the mating terminal arranged on an inner peripheral side or an outer peripheral side of the tube portion, and
a part facing the mating terminal, out of a tip peripheral edge of the tube portion, having an interference avoiding surface inclined toward a side away from the mating terminal toward a tip side of the tube portion.

2. The coaxial connector of claim 1, wherein the interference avoiding surface annularly extends along the tip peripheral edge of the tube portion.

3. The coaxial connector of claim 1, wherein the interference avoiding surface guides a resilient piece of the mating terminal at the tip peripheral edge of the tube portion.

4. The coaxial connector of claim 1, wherein the interference avoiding surface is formed on one of the inner peripheral side and the outer peripheral side of the tube portion and a surface of the other of the inner peripheral side and the outer peripheral side of the tube portion is formed into such a shape that a part having the same diameter is continuous along a center axis of the tube portion.

5. The coaxial connector of claim 1, wherein the interference avoiding surface is formed on one of the inner peripheral side and the outer peripheral side of the tube portion and a surface of the other of the inner peripheral side and the outer peripheral side of the tube portion is formed into a shape inclined toward the same side as inclination of the interference avoiding surface.

6. The coaxial connector of claim 5, wherein a slit dividing the interference avoiding surface is formed in the tip peripheral edge of the tube portion.

7. The coaxial connector of claim 6, wherein a width of the slit is smaller than a width of a resilient piece of the mating terminal.

8. The coaxial connector of claim 1, wherein:
the inner conductor includes an inner conductor tube portion serving as the tube portion,
the mating terminal is inserted into the inner conductor tube portion, and
an inner peripheral part of a tip peripheral edge of the inner conductor tube portion is formed with an inner interference avoiding surface serving as the interference avoiding surface.

9. The coaxial connector of claim 1, wherein:
the outer conductor includes an outer conductor tube portion serving as the tube portion,
the outer conductor tube portion is inserted into the mating terminal, and
an outer peripheral part of a tip peripheral edge of the outer conductor tube portion is formed with an outer interference avoiding surface serving as the interference avoiding surface.

10. A coaxial connector connection structure, comprising:
the coaxial connector of claim 1; and
the mating coaxial connector,
the mating coaxial connector including a mating inner conductor and a mating outer conductor surrounding an outer peripheral side of the mating inner conductor,
the mating inner conductor including an inner resilient piece for resiliently contacting the inner conductor, and
the mating outer conductor including an outer resilient piece for resiliently contacting the outer conductor.

11. The coaxial connector connection structure of claim 10, wherein:
the mating coaxial connector includes a mating dielectric located between a base end part of the mating inner conductor and a base end part of the mating outer conductor, and
the mating dielectric includes an annular recess facing the coaxial connector.
